(19) United States
(12) Patent Application Publication
(10) Pub. No.: US 2017/0138215 A1
(43) Pub. Date: May 18, 2017

(54) STEAM TURBINE, CONTROL METHOD, AND PROGRAM

(71) Applicants: MITSUBISHI HEAVY INDUSTRIES, LTD., Tokyo (JP); MITSUBISHI HEAVY INDUSTRIES COMPRESSOR CORPORATION, Tokyo (JP)

(72) Inventors: Takayuki KONO, Tokyo (JP); Katsuaki MORITA, Tokyo (JP); Makoto KATAGAKE, Hiroshima-shi (JP)

(73) Assignees: MITSUBISHI HEAVY INDUSTRIES, LTD., Tokyo (JP); MITSUBISHI HEAVY INDUSTRIES COMPRESSOR CORPORATION, Tokyo (JP)

(21) Appl. No.: 15/320,926

(22) PCT Filed: Jun. 30, 2015
(86) PCT No.: PCT/JP2015/068847

§ 371 Date: Dec. 21, 2016

(30) Foreign Application Priority Data
Sep. 9, 2014 (JP) 2014-183098

(51) Int. Cl. F01D 17/20

(52) U.S. Cl. CPC F01D 17/20; F05D 2270/02; F05D 2270/304; F05D 2270/62; F05D 2220/31

(57) ABSTRACT

A steam turbine is provided with an electric motor, a plurality of controller units, a status storing unit, and a master controller. The electric motor drives a regulating valve for controlling the opening and closing of a steam passage in which steam supplied to a turbine body is circulated. The plurality of controller units control the drive of the electric motor. The status storing unit stores a parameter indicating a status of the steam turbine. When there is an abnormality in a controller unit that is controlling the drive of the electric motor, the master controller switches the controller unit to a controller unit among the controller units that is not controlling the electric motor, and causes the relevant controller unit to operate after rewriting the parameter to a parameter stored by the status storing unit before the abnormality had occurred.

### TECHNICAL FIELD

The present invention relates to a steam turbine, a control method, and a program.

Priority is claimed on Japanese Patent Application No. 2014-183098, filed on Sep. 9, 2014, the content of which is incorporated herein by reference.

### BACKGROUND ART

There is a steam turbine which feeds back a measured value of a turbine rotating speed and compares the measured value and a target turbine rotating speed, and controls the turbine rotating speed based on a deviation therebetween.

As related art, PTL 1 discloses a technology which provides a preliminary controller unit and controls a steam turbine having redundancy.

### CITATION LIST

### Patent Literature

[PTL 1] Japanese Unexamined Patent Application Publication No. 2013-72349

### SUMMARY OF INVENTION

### Technical Problem

In the control of the steam turbine disclosed in PTL 1, a sequence of switching to the preliminary controller unit is not obvious. In addition, when a main controller unit is switched to the preliminary controller unit, it is necessary to detect from which status the preliminary controller unit is operated. However, in the control of the steam turbine disclosed in PTL 1, since a controller which detects the status of the preliminary controller unit does not exist in a case where there is an abnormality in the main controller unit, it is not possible to detect the status of the preliminary controller unit. As a result, even when the controller is switched to the preliminary controller unit, it is not possible to perform the control similar to the control before an abnormality occurs. In addition, in the control of the steam turbine disclosed in PTL 1, an operation is continuously performed in a status in which feedback is not applied from an electric actuator to the controller unit in the middle of the main controller unit being switched to the preliminary controller unit. Accordingly, operation conditions of the control unit after the switching is performed may be different from operation conditions of the control unit before the switching is performed, and the turbine rotating speed may deviate greatly from the target turbine rotating speed. In a case where the turbine rotating speed deviates greatly from the target turbine rotating speed, a control amount becomes excessive. As a result, each movable portion such as an electric motor, the electric actuator, or a turbine body is likely to operate rapidly, and in some cases, each movable portion is likely to be damaged.

Accordingly, in the steam turbine, even in a case where an abnormality occurs in the controller unit which controls the drive of the electric motor, a technology capable of controlling the controller unit such that the turbine rotating speed becomes the target turbine rotating speed and restoring the control to a stable status in which damage does not occur is required.

The present invention provides a steam turbine, a control method, and a program in which the above-described problems can be solved.

### Solution to Problem

According to a first aspect of the present invention, there is provided a steam turbine, including: an electric motor which drives a regulating valve for regulating opening and closing of a steam passage through which steam supplied to a turbine body is circulated; a plurality of controller units which control drive of the electric motor; a status storing unit which stores a parameter indicating a status of the steam turbine; and a master controller which switches the controller unit to a controller unit among the controller units which is not controlling the electric motor in a case where there is an abnormality in the controller unit which controls the drive of the electric motor, and operates the controller unit after rewriting the parameter to a parameter stored by the status storing unit before the abnormality occurs.

According to a second aspect of the present invention, in the above-described steam turbine, the status storing unit stores a turbine rotating speed which is detected in the turbine body serving as the parameter.

According to a third aspect of the present invention, in the above-described steam turbine, the status storing unit stores a valve opening degree for controlling the regulating valve serving as the parameter.

According to a fourth aspect of the present invention, in the above-described steam turbine, the status storing unit stores a deviation between a target turbine rotating speed and the detected turbine rotating speed serving as the parameter.

According to a fifth aspect of the present invention, there is provided a control method of a steam turbine, including: a plurality of controller units which control drive of an electric motor which drives a regulating valve for regulating opening and closing of a steam passage through which steam supplied to a turbine body is circulated; a status storing unit which stores a parameter indicating a status of the steam turbine; and a master controller which switches the controller unit to a controller unit among the controller units which is not controlling the electric motor in a case where there is an abnormality in the controller unit which controls the drive of the electric motor, and operating the controller unit after rewriting the parameter to a parameter stored by the status storing unit before the abnormality occurs.

According to a sixth aspect of the present invention, there is provided a program causing a computer to operate: an electric motor which drives a regulating valve for regulating opening and closing of a steam passage through which steam supplied to a turbine body is circulated; a plurality of controller units which control drive of the electric motor; a status storing unit which stores a parameter indicating a status of the steam turbine; and a master controller which switches the controller unit to a controller unit among the controller units which is not controlling the electric motor in a case where there is an abnormality in the controller unit which controls the drive of the electric motor, and operates the controller unit after rewriting the parameter to a parameter stored by the status storing unit before the abnormality occurs.

### Advantageous Effects of Invention

According to the above-described steam turbine, the control method, and the program, even in a case where an abnormality occurs in the controller unit which controls the drive of the electric motor, the control is performed such that the turbine rotating speed becomes the target turbine rotating speed, and it is possible to restore the control to a stable status in which damage does not occur.

### BRIEF DESCRIPTION OF DRAWINGS

FIG. 1 is a diagram showing an example of a configuration of a steam turbine according to a first embodiment of the present invention.

FIG. 2 is a first diagram showing an example of a configuration of a control system which controls an electric actuator in the steam turbine according to the present embodiment.

FIG. 3 is a first view showing an example of an internal structure of an electric actuator according to the present embodiment.

FIG. 4 is a second view showing an example of the internal structure of the electric actuator according to the present embodiment.

FIG. 5 is a diagram showing an example of transmitting and receiving of a signal which controls the electric actuator in the steam turbine according to the present embodiment.

FIG. 6 is a diagram showing an example of details of the signal which controls the electric actuator in the steam turbine according to the present embodiment.

FIG. 7 is a second diagram showing an example of the configuration of the control system which controls the electric actuator in the steam turbine according to the present embodiment.

FIG. 8 is a diagram showing an example of a processing flow in the steam turbine in a case where an abnormality occurs in a controller according to the present invention.

FIG. 9 is a diagram showing an example of a processing flow in the steam turbine in a case where an abnormality occurs in an amplifier according to the present invention.

### DESCRIPTION OF EMBODIMENTS

### Embodiment

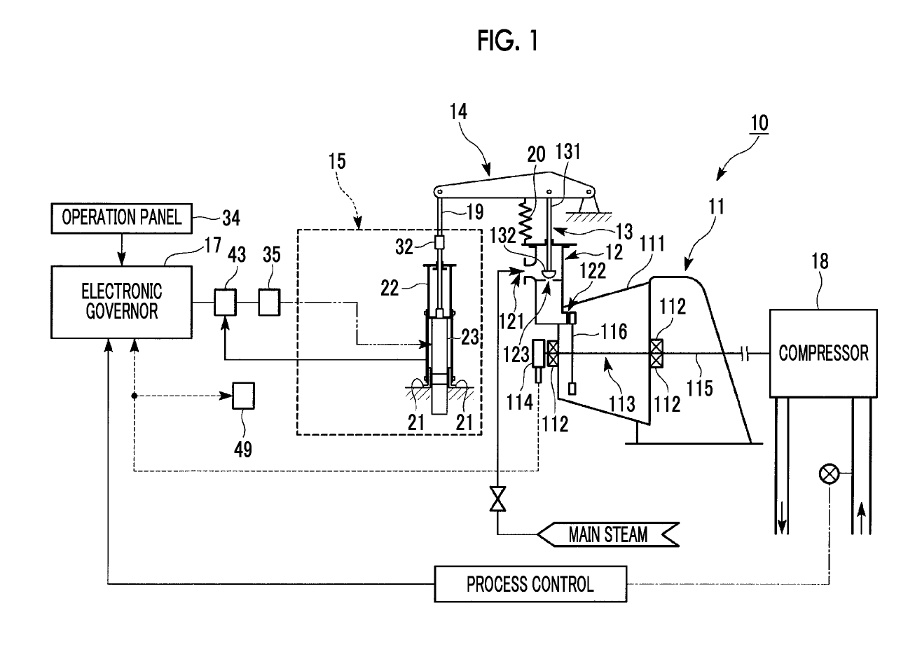

FIG. 1 is a diagram showing an example of a configuration of a steam turbine 10 according to a first embodiment of the present invention.

As shown in FIG. 1, the steam turbine 10 according to the present embodiment includes a turbine body 11, a steam passage 12, a regulating valve 13, a lever member 14, an opening-closing drive mechanism 15, an electronic governor 17, a controller unit 35, a master controller 43, and a status storing unit 49.

As shown in FIG. 1, the turbine body 11 includes a tubular casing 111, bearings 112 which are provided in the casing 111, a rotor 113 which rotatably supports the bearings 112 and is disposed inside the casing 111, and a speed detection sensor 114 which detects a rotating speed of the rotor 113.

The rotor 113 includes a rotary shaft 115, and a blade 116 which is fixed to the rotary shaft 115. The blade 116 is rotated by steam, and a compressor 18 is driven by the turning force.

The bearings 112 rotatably support the rotary shaft 115 included in the rotor 113.

Steam is supplied to the turbine body 11 through the steam passage 12. As shown in FIG. 1, the steam passage includes a steam introduction port 121 and a steam supply port 122. In the steam passage 12, steam is introduced from the steam introduction port 121, and the steam supply port 122 is connected to the turbine body 11. A throttle hole 123 in which a passage width of the steam passage 12 is narrowed is provided between the steam introduction port 121 and the steam supply port 122.

In addition, as the “steam passage” according to the present invention, the passage through which steam supplied to the turbine body 11 is circulated is described as an example. However, the steam passage 12 is not limited to this, and for example, the “steam passage” may be a passage through which steam extracted from the turbine body 11 is circulated.

The regulating valve 13 regulates an amount of the steam supplied to the turbine body 11. As shown in FIG. 1, the regulating valve 13 includes a rod-shaped arm member 131 and an approximately semicircular sealing member 132. In the regulating valve 13, the sealing member 132 is provided on one end portion of the arm member 131, and the other end portion of the arm member 131 is fixed to the intermediate portion in the longitudinal direction of the lever member 14. According to the regulating valve 13, the arm member 131 linearly moves along the steam passage 12, and the sealing member 132 is fitted to the throttle hole 123 of the steam passage 12, or is separated from the throttle hole 123. Accordingly, an opening status of the throttle hole 123 is changed, and a flow rate of steam which is supplied to the turbine body 11 via the throttle hole 123 is changed.

The lever member 14 transmits the output of the opening-closing drive mechanism 15 to the regulating valve 13. As shown in FIG. 1, in the lever member 14, the proximal portion in the longitudinal direction is rotatably supported, and one end portion of a lever side rod 19 is fixed to the proximal portion in the longitudinal direction. In addition, as described above, in the intermediate portion in the longitudinal direction of the lever member 14, one end portion of a pull spring 20 serving as forcible closing means for forcibly closing the regulating valve 13 is attached to a side closer to the distal end than the fixed position of the arm member 131 configuring the regulating valve 13. The other end portion of the pull spring 20 is fixed to be immovable. In a status in which an external force is not applied to the pull spring 20, in FIG. 1, the pull spring 20 applies tension in a direction in which the lever member 14 is rotated in the counterclockwise direction.

The opening-closing drive mechanism 15 drives the regulating valve 13. The opening-closing drive mechanism 15 includes a pair of brackets 21, a holding member 22, and an electric actuator 23.

As shown in FIG. 1, the pair of bracket 21 included in the opening-closing drive mechanism 15 is installed so as to be fixed.

The holding member 22 holds the electric actuator 23.

The electric actuator 23 generates a driving force for driving the regulating valve 13.

A coupling 32 connects the electric actuator 23 side rod and the lever side rod 19 to each other.

As shown in FIG. 1, a result of a process control which is performed based on the detection results of a pressure or a temperature in the compressor 18 is input to the electronic governor 17. In addition, a rotating speed (hereinafter, referred to a “turbine rotating speed”) of the blade 116 which is detected by the speed detection sensor 114 configuring the turbine body 11 is input to the electronic governor 17. The speed detection sensor 114 has a function of a pulse sensor, and in this case, the pulse signal according to the rotating speed serving as the turbine rotating speed from the speed detection sensor 114 is input to the electronic governor 17. In addition, an instruction of a user input from an operation panel 34 is input to the electronic governor 17. As a result of the input process control, the electronic governor 17 generates signals corresponding to a control valve opening degree based on the turbine rotating speed and the instruction of the user. In addition, the electronic governor 17 outputs signals indicating the generated control valve opening degree to the master controller 43.

The controller unit 35 (main controller unit 35a and preliminary controller unit 35b) controls an operation of the opening-closing drive mechanism 15.

The master controller 43 controls the main controller unit 35a (the preliminary controller unit 35b in a case where an abnormality occurs in the main controller unit 35a) based on the control valve opening degree input from the electronic governor 17. More specifically, the master controller 43 outputs the control valve opening degree to the controller unit 35, and the controller unit 35 controls the electric actuator 23 based on the control valve opening degree.

The status storing unit 49 stores a parameter indicating the status of the steam turbine. For example, the parameter indicating the status of the steam turbine includes a turbine rotating speed in the turbine body 11 detected by the speed detection sensor 114, a valve opening degree for controlling the regulating valve 13, a deviation between a target turbine rotating speed and the detected turbine rotating speed, or the like. The status storing unit 49 samples the parameter for a predetermined period and stores the parameter. In this case, the status storing unit 49 rewrites the parameter on data stored last lime and stores the parameter. In addition, FIG. 1 shows an example in a case where the status storing unit 49 stores the turbine rotating speed, and the connection destination of the status storing unit 49 is not limited to the shown example. The connection destination of the status storing unit 49 may be different according to the stored parameter.

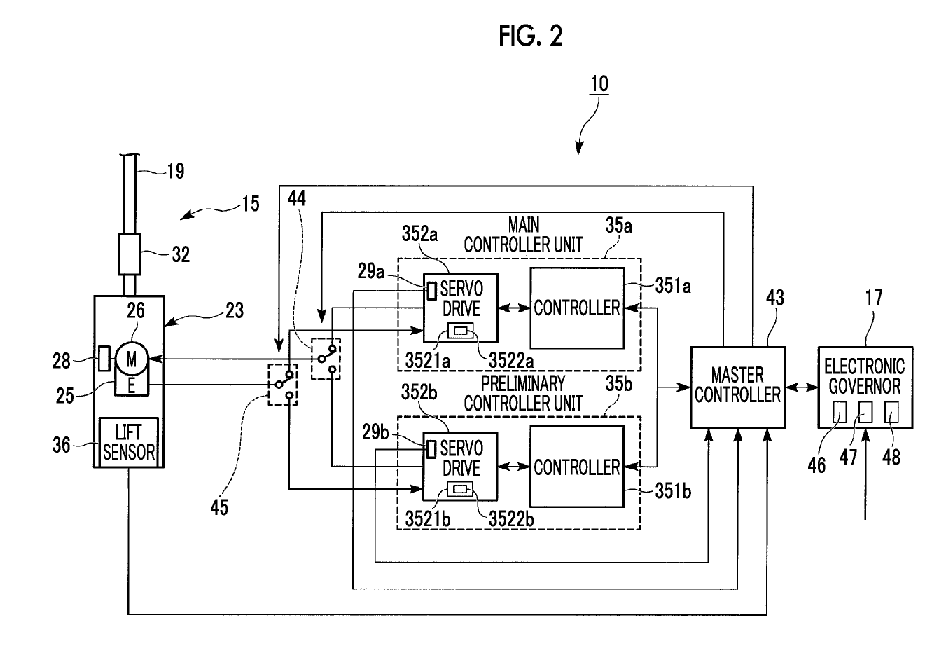

FIG. 2 is a first diagram showing an example of a configuration of a control system which controls the electric actuator 23 in the steam turbine 10 according to the present embodiment.

In FIG. 2, among the configurations of the steam turbine 10 shown in FIG. 1, the opening-closing drive mechanism 15, the electronic governor 17, the electric actuator 23, the main controller unit 35a, the preliminary controller unit 35b, and the master controller 43 are shown.

The electronic governor 17 includes a deviation counter 46, a PID controller 47, and a switch 48.

The electric actuator 23 generates a driving force for driving the regulating valve 13. The electric actuator 23 includes an encoder 25, an electric motor 26, a brake 28, and a lift sensor 36.

The main controller unit 35a includes a controller 351a and a servo drive 352a. In addition, the servo drive 352a includes an abnormality detection circuit 29a and an amplifier 3521a. Moreover, the amplifier 3521a includes an electromagnetic contactor (MC) 3522a.

The preliminary controller unit 35b includes a controller 351b and a servo drive 352b. Moreover, the servo drive 352b includes an abnormality detection circuit 29b and an amplifier 3521b. In addition, the amplifier 3521b includes an electromagnetic contactor (MC) 3522b.

The turbine rotating speed, the process control, and the instruction of the user are input to the electronic governor 17.

The deviation counter 46 included in the electronic governor 17 calculates a deviation by subtracting the turbine rotating speed input to the electronic governor 17 from the target turbine rotating speed which is the target of the turbine rotating speed. The deviation counter 46 outputs the calculated deviation to the PID controller 47 via the switch 48.

If the deviation is input from the deviation counter to the PID controller 47, the PID controller 47 generates signals indicating the control valve opening degree for performing the PID control by which the turbine rotating speed approaches the target turbine rotating speed, based on the input deviation, and the process control and the instruction of the user input to the electronic governor 17. The PID controller 47 outputs the generated control valve opening degree to the master controller 43.

The switch 48 is provided between the deviation counter 46 and the PID controller 47, and switches the status between an energized status and a non-energized status based on the switch control signal from the master controller 43.

The electric actuator 23 generates a driving force for driving the regulating valve 13. The electric actuator 23 includes the encoder 25, the electric motor 26, the brake 28, and the lift sensor 36.

The encoder 25 sends the signals corresponding to the rotating speed of the electric motor 26 to the amplifier 3521a included in the servo drive 352a via an encoder switch 45. Since the encoder 25 sends the signals corresponding to the rotating speed of the electric motor to the servo drive 352a, the controller 351a can control the servo drive 352a with high accuracy.

The electric motor 26 converts supplied power into rotation energy based on the control signals input from the controller unit 35 via the magnet switch 44.

The brake 28 brakes the rotation of the electric motor 26 in a case where the abnormality detection circuit 29a detects an abnormality of the controller 351a or the amplifier 3521a and power supplied to the brake 28 is turned off.

The abnormality detection circuit 29a is a circuit which detects the abnormality of the controller 351a or the amplifier 3521a, and causes the brake 28 to brake the rotation of the electric motor 26 in a case where an abnormality is detected. For example, in a case where the electric motor control signal input from the main controller unit 35a to the electric motor 26 indicates a predetermined variation amount and variation equal to or more than a threshold value is detected, the abnormality detection circuit 29a determines that an abnormality occurs in the controller 351a or the amplifier 3521a. In addition, the abnormality detection circuit 29a turns off the power supplied to the brake 28.

In addition, in a case where an abnormality occurs, the abnormality detection circuit 29a sends an abnormality occurrence signal informing occurrence of the abnormality to the master controller 43.

The control valve opening degree is input from the master controller 43 to the main controller unit 35a, and the main controller unit 35a controls the operation of the electric actuator 23 based on the input control valve opening degree.

More specifically, the controller 351a included in the main controller unit 35a outputs a position command to the amplifier 3521a based on the input control valve opening degree. The amplifier 3521a sends the electric motor control signal to the electric motor 26 based on the position command input from the controller 351a and the signal corresponding to the rotating speed of the electric motor 26 input via the encoder switch 45 from the encoder 25.

In addition, each of the controller 351a and the amplifier 3521a has a self diagnosis function by which whether or not an abnormality occurs can be determined. If an execution command of the self diagnosis is input from the master controller 43 to the controller 351a, the controller 351a performs the self diagnosis and outputs the execution command of the self diagnosis to the amplifier 3521a. If the execution command of the self diagnosis is input from the controller 351a to the amplifier 3521a, the amplifier 3521a performs the self diagnosis. The amplifier 3521a outputs a diagnosis result of the performed self diagnosis to the controller 351a. If the self diagnosis result is input from the amplifier 3521a to the controller 351a, the controller 351a sends the self diagnosis result of the amplifier 3521a and the self diagnosis result of the self amplifier to the master controller 43.

In addition, the electromagnetic contactor (MC) 3522a is provided between the amplifier 3521a and a primary power source (not shown) of the amplifier 3521 (3521a and 3521b), and the electromagnetic contactor 3522a provides power from the primary power source to the amplifier 3521a in a case where the status becomes an energized status, and interrupts the supply of power from the primary power of the amplifier 3521 to the amplifier 3521a in a case where the status becomes a non-energized status.

The master controller 43 outputs the control valve opening degree input from the electronic governor 17 to the main controller unit 35a.

In addition, if the master controller 43 receives the abnormality occurrence signal from the abnormality detection circuit 29a, the master controller 43 sends the execution command of the self diagnosis to the controller 351a. In addition, the master controller 43 receives the self diagnosis result of the amplifier 3521a and the self diagnosis result of the controller 351a from the controller 351a. If any one of the received self diagnosis result of the amplifier 3521a and the self diagnosis result of the controller 351a is a self diagnosis result indicating an abnormality, the master controller 43 switches the connection of each of the magnet switch 44 and the encoder switch 45 from the main controller unit 35a side to the preliminary controller unit 35b side. In addition, the master controller 43 sends an abnormality information signal indicating that an abnormality occurs in the steam turbine 10 to the electronic governor 17.

As described above, in the steam turbine 10 according to the present embodiment, the master controller 43 controls the controller unit 35 and the controller unit controls the operation of the electric actuator 23 based on the control of the electronic governor 17. The regulating valve 13 is operated based on the control with respect to the operation of the electric actuator 23, and the amount of the steam supplied to the turbine body 11 is regulated.

In addition, in a case where an abnormality occurs in the main controller unit 35a, the master controller 43 switches the connection destinations of the magnet switch and the encoder switch 45, and the connection is switched from the main controller unit 35a to the preliminary controller unit 35b.

In addition, since the preliminary controller unit 35b has the configuration similar to that of the main controller unit 35a, detailed descriptions thereof are omitted.

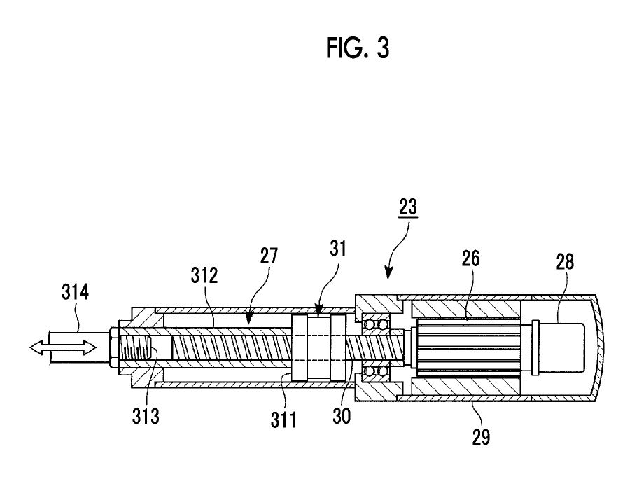

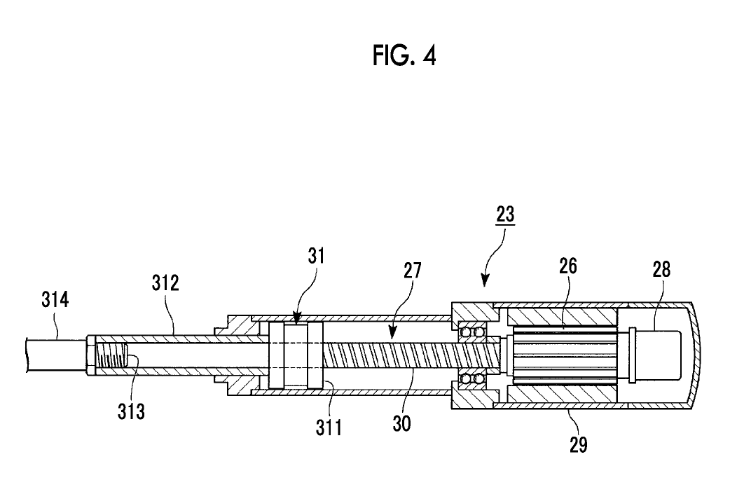

FIGS. 3 and 4 show an example of the internal structure of the electric actuator 23.

As shown in FIG. 3, the electric motor 26 is accommodated in a motor accommodation portion which is provided on the proximal portion of the electric actuator 23 and has a sealed inner portion.

As shown in FIG. 3, a conversion mechanism 27 includes a ball screw 30 which is connected to the drive shaft of the electric motor 26, and a piston unit 31 which is moved forward and backward by the rotation of the ball screw 30.

As shown in FIG. 3, the ball screw 30 is a long screw member, and male screws are formed on the outer circumferential surface of the ball screw 30. One end portion of the ball screw 30 is connected to the drive shaft of the electric motor 26, and the ball screw 30 is rotated by the rotation of the electric motor 26.

The piston unit 31 reciprocates along the ball screw 30. The piston unit 31 is a member having an approximately annular shape, and as shown in FIG. 3 includes a nut 311, a piston rod 312, a rod end connector 313, and an actuator side rod 314.

The nut 311 is screwed to the ball screw 30 in which female screws are formed on the inner circumferential surface of the electric actuator 23.

The piston rod 312 is formed in a tubular shape, is fixed to one end surface of the nut 311, and covers the outer portion of the ball screw 30.

The rod end connector 313 is fitted to and mounted on the distal portion of the piston rod 312.

One end portion of the actuator side rod 314 in the longitudinal direction is fixed to the rod end connector 313.

Accordingly, in the piston unit 31, if the ball screw 30 rotates around the axis, as shown in FIG. 4, the nut 311 screwed to the ball screw 30 moves along the axis. In addition, according to the movement of the nut 311, the piston rod 312, the rod end connector 313, and the actuator side rod 314 fixed to the nut 311 move along the axis of the ball screw 30 along with the nut 311.

The brake 28 is a non-excitation actuating electromagnetic brake which performs connection, separation, braking, and holding of machines by an electromagnetic force generated by supplying power to a coil. As shown in FIG. 3, the brake 28 is provided at a position opposite to the ball screw 30 in a state where the electric motor 26 is interposed therebetween. The operation of the brake 28 is controlled by the electronic governor 17 shown in FIG. 1. More specifically, in a case where the circumferential speed of the ball screw 30 increases and exceeds a threshold value, the electronic governor 17 controls the brakes 28 to be operated, and braking is applied to the rotation of the electric motor 26. In addition, in a case where supply of power to the electric motor 26 is stopped due to a power cut or the like, the electronic governor 17 controls the brake 28 such that the brake 28 is operated during a predetermined time after the supply of power is stopped, and braking is applied to the rotation of the electric motor 26.

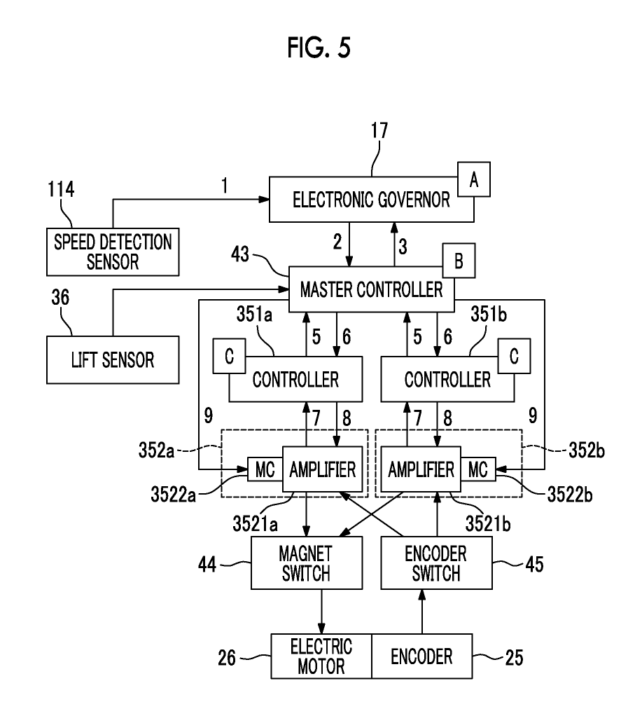

FIG. 5 is a diagram showing an example of transmitting and receiving of a signal which controls the electric actuator 23 in the steam turbine 10 according to the present embodiment.

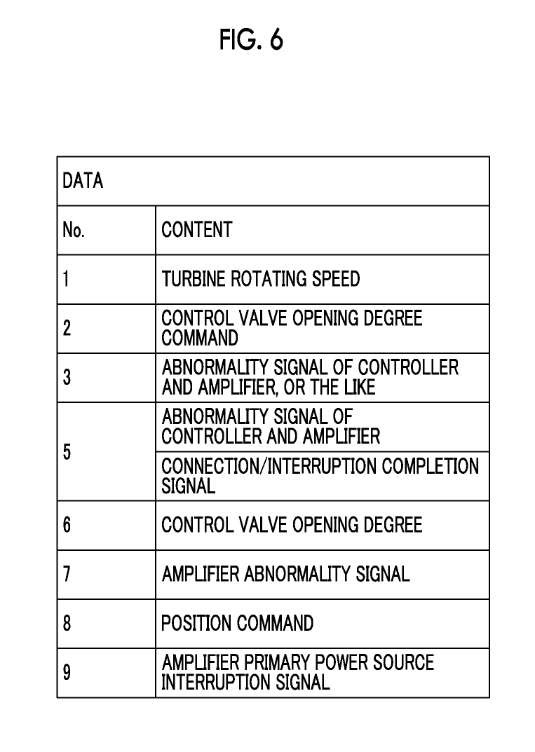

In addition, FIG. 6 is a diagram showing an example of a content of the signal which controls the electric actuator 23 in the steam turbine 10 according to the present embodiment.

The content of the signal in FIG. 6 is an example of the content of the signal with respect to the steam turbine 10 according to the present embodiment shown in FIG. 5.

Numbers such as 1 to 9 shown by respective arrows in FIG. 5 indicate “Data No.” shown in FIG. 6. In addition, a starting point of each arrow indicates a function unit which sends a signal indicated by the number, and an end point of each arrow indicates a function unit which receives a signal indicated by the number.

For example, in FIG. 5, the signal indicated by the number 1 is a signal indicating the turbine rotating speed. The electronic governor 17 acquires the signal indicating the turbine rotating speed from the speed detection sensor 114.

The signal indicated by the number 2 is a signal indicating the control valve opening degree. The electronic governor 17 generates the signal indicating the control valve opening degree based on the turbine rotating speed, and sends the generated signal to the master controller 43.

The signal indicated by the number 3 is an abnormality signal (abnormality information signal) indicating the abnormality of the controller 351a, the controller 351b, the amplifier 3521a, the amplifier 3521b, or the like. In a case where the master controller 43 receives the self diagnosis result indicating the abnormality of the amplifier 3521 or the controller 351 from the controller 351 (351a and 351b), the master controller 43 sends the abnormality signal (abnormality information signal) to the electronic governor 17.

The signal indicated by the number 5 is the abnormality signal (self diagnosis result indicating abnormality) indicating the abnormality of the controller and the amplifier, or a connection/interruption completion signal between the controller and the amplifier, and the electric motor 26. The master controller 43 sends the execution command of the self diagnosis to the controller 351, and acquires the abnormality signal (self diagnosis result indicating abnormality) in a case where an abnormality occurs in the amplifier 3521 or the controller 351. In addition, when the main controller unit 35a is switched to the preliminary controller unit 35b, the master controller 43 acquires the connection/interruption completion signal. The signal indicated by the number 5, in which the master controller 43 acquires from the controller 351a, is the abnormality signal indicating the abnormality of the controller 351a and the amplifier 3521a, or an interruption completion signal of the controller 351a. In addition, the signal indicated by the number 5, in which the master controller 43 acquires from the controller 351b, is the abnormality signal indicating the abnormality of the controller 351b and the amplifier 3521b, or a connection completion signal of the controller 351b.

The signal indicated by the number 6 is a signal indicating the control valve opening degree. The master controller 43 sends the signal indicating the control valve opening degree to the controller 351. In a case where the controller 351a and the amplifier 3521a are normal, the master controller 43 sends the signal indicating the control valve opening degree to the controller 351a. In a case where an abnormality occurs in the controller 351a or the amplifier 3521a, the master controller 43 changes the connection from the controller 351a to the controller 351b, and sends the signal indicating the control valve opening degree to the controller 351b.

The signal indicated by the number 7 is the abnormality signal indicating the abnormality of the amplifier 3521. In a case where the controller 351 receives the execution command of the self diagnosis from the master controller 43, the controller 351 outputs the execution command of the self diagnosis to the amplifier 3521, and in a case where an abnormality occurs in the amplifier 3521, the controller 351 acquires the abnormality signal (self diagnosis result) of the amplifier 3521. The controller 351a acquires the abnormality signal of the amplifier 3521a, and the controller 351b acquires the abnormality signal of the amplifier 3521b.

The signal indicated by the number 8 is a rotation position command for moving the movable portion of the electric actuator 23 to a target position. The controller 351 sends the position command to the amplifier 3521. The controller 351a sends the rotation position command to the amplifier 3521a, and the controller 351b sends the rotation position command to the amplifier 3521b.

The signal indicated by the number 9 is an amplifier primary power source interruption signal which causes the electromagnetic contactor (“MC” in FIG. 5) 3522 (3522a and 3522b) provided between the amplifier 3521 and the primary power source of the amplifier 3521 to be a non-conduction status so as to interrupt the power supplied to the amplifier 3521 when the controller unit 35 is switched. In a case where the master controller 43 acquires the abnormality signal, the master controller 43 sends the amplifier primary power source interruption signal to the electromagnetic contactor 3522. In a case where the master controller 43 acquires the abnormality signal of the controller 351a or the amplifier 3521a, the master controller 43 sends the amplifier primary power source interruption signal to the electromagnetic contactor 3522a. Moreover, in a case where the master controller 43 acquires the abnormality signal of the controller 351b or the amplifier 3521b, the master controller 43 sends the amplifier primary power source interruption signal to the electromagnetic contactor 3522b.

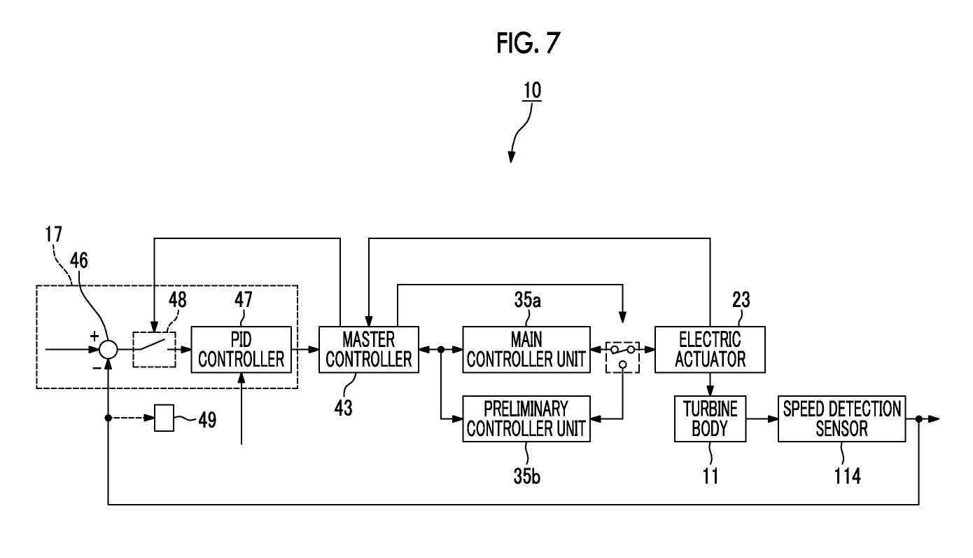

FIG. 7 is a second diagram showing an example of the configuration of the control system which controls the electric actuator 23 in the steam turbine 10 according to the present embodiment.

Here, an example is shown in which the electronic governor 17 includes the deviation counter 46 and the PID controller 47.

The turbine rotating speed, the process control, and the instruction of the user are input to the electronic governor 17.

The target turbine rotating speed and the turbine rotating speed which is detected by the speed detection sensor 114 are input to the deviation counter 46, and the deviation counter 46 subtracts the turbine rotating speed from the target turbine rotating speed. The deviation counter 46 outputs the deviation which is obtained by subtracting the turbine rotating speed from the target turbine rotating speed to the PID controller 47 via the switch 48.

The PID controller 47 generates signals indicating the control valve opening degree for performing the PID control by which the turbine rotating speed approaches the target turbine rotating speed, based on the input deviation, and the process control and the instruction of the user input to the electronic governor 17. The PID controller 47 outputs the signal indicating the control valve opening degree to the master controller 43.

The signal indicating the control valve opening degree is input from the PID controller 47 to the master controller 43. In addition, the master controller 43 outputs the control valve opening degree to the main controller unit 35a (the preliminary controller unit 35b in the case where an abnormality occurs in the main controller unit 35a).

The control valve opening degree is input from the master controller 43 to the main controller unit 35a. The main controller unit 35a controls the operation of the electric motor 26 configuring the electric actuator 23 based on the input control valve opening degree.

The electric actuator 23 opens and closes the valve based on the control of the main controller unit 35a (the preliminary controller unit 35b in the case where an abnormality occurs in the main controller unit 35a), and regulates the amount of steam respect to the turbine body 11.

The blade 116 included in the turbine body 11 is rotated by steam.

The speed detection sensor 114 detects the turbine rotating speed, and feeds back the turbine rotating speed to the deviation counter 46 as a pulse signal.

Next, a control in the steam turbine 10 in a case where any one of the abnormality of the controller 351a included in the main controller unit 35a and the abnormality of the amplifier 3521a included in the main controller unit 35a occurs will be described.

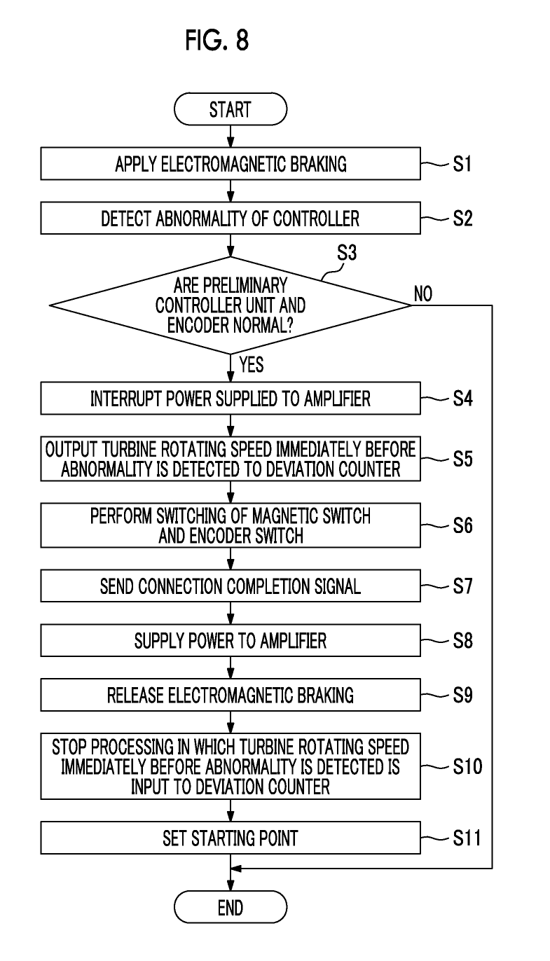

FIG. 8 is a diagram showing an example of a processing flow in the steam turbine 10 in a case where an abnormality occurs in a controller 351a according to the present invention.

First, the control in the steam turbine 10 in the case where an abnormality occurs in the controller 351a included in the main controller unit 35a will be described.

In addition, here, the control is mainly described according to the control block shown in FIG. 7. However, the above-described function units which are not shown in FIG. 7 are used to describe the processing of the control.

It is assumed that an abnormality occurs in the controller 351a included in the main controller unit 35a in a status in which the main controller unit 35a controls the electric actuator 23.

The abnormality detection circuit 29a included in the servo drive 352a turns off the power supplied to the brake 28 if an abnormality is detected in the controller 351a. Accordingly, the brake 28 applies electromagnetic braking according to the turning off of the power supply (Step S1). For example, in a case where the electric motor control signal input from the main controller unit 35a to the electric motor 26 detects variation equal to or more than a threshold value indicating a predetermined variation amount, the abnormality detection circuit 29a determines that an abnormality occurs in the controller 351a or the amplifier 3521a.

In the case where the abnormality detection circuit 29a detects an abnormality, the abnormality detection circuit 29a sends an abnormality occurrence signal informing occurrence of the abnormality to the master controller 43.

If the master controller 43 receives the abnormality occurrence signal from the abnormality detection circuit 29a, the master controller 43 sends the execution command of the self diagnosis to the controller 351a.

If the execution command of the self diagnosis is input from the master controller 43 to the controller 351a, the controller 351a performs the self diagnosis and outputs the execution command of the self diagnosis to the amplifier 3521a. If the execution command of the self diagnosis is input from the controller 351a to the amplifier 3521a, the amplifier 3521a performs the self diagnosis. The amplifier 3521a outputs the diagnosis result of the performed self diagnosis to the controller 351a. If the self diagnosis result is input from the amplifier 3521a to the controller 351a, the controller 351a sends the self diagnosis result of the amplifier 3521a and the self diagnosis result of the self amplifier to the master controller 43. Here, the master controller 43 detects the abnormality of the controller 351a by the acquisition of the self diagnosis result indicating an abnormality (Step S2).

If the master controller 43 detects the abnormality of the controller 351a, the master controller 43 determines whether or not the preliminary controller unit 35b and the encoder 25 is normal (Step S3). For example, if the master controller 43 detects the abnormality of the controller 351a, the master controller 43 executes a self diagnosis program by which whether or not the function is normal is determined, and outputs an instruction for returning the diagnosis result to each of the preliminary controller unit 35b and the encoder 25.

In addition, in a case where the master controller 43 receives the diagnosis results indicating normal states from both the preliminary controller unit 35b and the encoder 25, the master controller 43 determines that the preliminary controller unit 35b and the encoder 25 are normal (YES in Step S3).

In addition, in a case where the master controller receives the diagnosis result indicating abnormality from at least one of the preliminary controller unit 35b and the encoder 25, the master controller 43 determines that at least one of the preliminary controller unit 35b and the encoder 25 are not normal (NO in Step S3).

In the case where the master controller 43 determines that at least one of the preliminary controller unit 35b and the encoder 25 are not normal (NO in Step S3) in the processing of Step S3, the master controller 43 stops the operation of the steam turbine 10 and ends the processing.

In addition, in the case where the master controller 43 determines that the preliminary controller unit 35b and the encoder 25 are normal (YES in Step S3) in the processing of Step S3, the master controller 43 sends the amplifier primary power source interruption signal for interrupting the power supplied to the amplifier 3521a to the electromagnetic contactor 3522a included in the main controller unit 35a.

If the electromagnetic contactor 3522a receives the amplifier primary power source interruption signal from the master controller 43, the electromagnetic contactor 3522a becomes a non-conduction status. In addition, the electromagnetic contactor 3522a interrupts the power supplied to the amplifier 3521a (Step S4). In this case, the status storing unit 49 outputs the turbine rotating speed immediately before the master controller 43 detects the abnormality of the controller 351a to the deviation counter 46 (Step S5). For example, the status storing unit 49 includes a storage unit and a buffer circuit. The status storing unit 49 is connected to a negative input terminal of the deviation counter 46, and stores the turbine rotating speed for a predetermined period. In addition, in the case where the master controller 43 detects the abnormality of the controller 351a, the status storing unit 49 outputs the turbine rotating speed stored immediately before the abnormality of the controller 351a is detected based on the instruction from the master controller 43 to the negative input terminal of the deviation counter 46.

After the master controller 43 sends the amplifier primary power source interruption signal of the amplifier 3521a to the electromagnetic contactor 3522a included in the main controller unit 35a, the master controller 43 sends the switch control signal by which the connection destination of the electric actuator 23 is switched from the main controller unit 35a to the preliminary controller unit 35b to each of the magnet switch 44 and the encoder switch 45.

If each of the magnet switch 44 and the encoder switch 45 receives the switch control signal from the master controller 43, each of the magnet switch 44 and the encoder switch 45 switches the connection destination of the electric actuator 23 from the main controller unit 35a to the preliminary controller unit 35b (Step S6).

The preliminary controller unit 35b is connected to the electric actuator 23 by the processing of Step S6. If the preliminary controller unit 35b is connected to the electric actuator 23, the controller 351b included in the preliminary controller unit 35b sends a connection completion signal informing connection completion to the master controller 43 (Step S7).

If the master controller 43 receives the connection completion signal from the controller 351b, the master controller 43 sends an amplifier primary power source supply signal for supplying power to the amplifier 3521b to the electromagnetic contactor 3522b.

If the electromagnetic contactor 3522b receives the amplifier primary power source supply signal from the master controller 43, the electromagnetic contactor 3522b becomes a conduction status. In addition, the electromagnetic contactor 3522b supplies power from the primary power source to the amplifier 3521b (Step S8). The amplifier 3521b supplies power to the brake 28 to release electromagnetic braking (Step S9). In this case, the turbine rotating speed immediately before the master controller 43 detects an abnormality is input from the status storing unit 49 to the deviation counter 46. As a result, the signal which is input to the preliminary controller unit 35b when the connection to the electric actuator 23 is switched from the main controller unit 35a to the preliminary controller unit 35b is the same as the signal which is input to the main controller unit 35a immediately before the master controller 43 detects an abnormality. That is, the parameter indicating the status in the steam turbine 10 is returned to the parameter indicating the status immediately before the master controller 43 detects an abnormality.

Here, the processing in which the turbine rotating speed is input from the status storing unit 49 to the deviation counter 46 is stopped (Step S10).

The master controller 43 sends a starting point set instruction for determining a starting point which becomes the reference of the rotation position of the electric motor 26 to the controller 351b.

If the controller 351b receives the starting point set instruction from the master controller 43, the controller 351b determines the starting point based on the input starting point set instruction (Step S11). For example, the controller 351b receives a signal indicating a current stroke length serving as the starting point set instruction from the master controller 43, that is, a lift sensor signal which is the signal indicating the deviation from the starting point which becomes the reference of the rotation position of the electric motor 26. The controller 351b determines the starting point of the electric motor 26 based on the deviation from the starting point indicated by the received lift sensor signal.

In this way, the control in the steam turbine 10 is restored using the preliminary controller unit 35b.

Hereinbefore, the control in the steam turbine 10 in the case where an abnormality occurs in the controller 351a included in the main controller unit 35a is described.

The status storing unit 49 stores the turbine rotating speed immediately before the master controller 43 detects the abnormality of the controller 351a. The status storing unit 49 inputs the stored turbine rotating speed to the deviation counter 46. In this status, the main controller unit 35a is switched to the preliminary controller unit 35b. In addition, the status storing unit stops the processing by which the turbine rotating speed immediately before an abnormality is detected is input to the deviation counter 46.

Accordingly, the control in the steam turbine 10 can be restarted from the status immediately before the master controller 43 detects an abnormality. In addition, the master controller 43 can hold the deviation immediately before the abnormality of the controller 351a is detected, and a control of a gain of the PID controller 47 can be restarted from the gain immediately before an abnormality is detected. As a result, even in a case where an abnormality occurs in the controller unit which controls the drive of the electric motor, the steam turbine 10 is controlled such that the turbine rotating speed becomes the target turbine rotating speed, and it is possible to restore the control to a stable status in which damage does not occur.

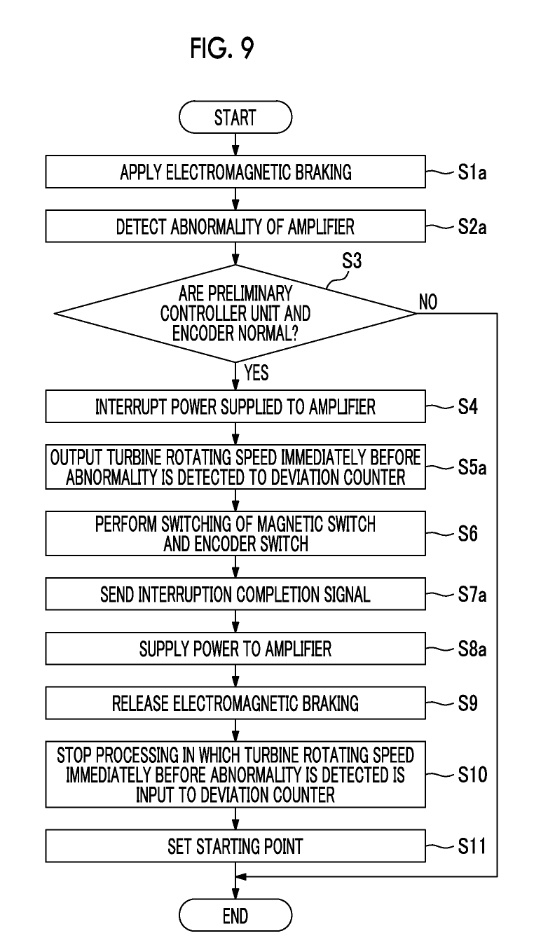

FIG. 9 is a diagram showing an example of a processing flow in the steam turbine 10 in a case where an abnormality occurs in the amplifier 3521a.

Next, the control in the steam turbine 10 in the case where an abnormality occurs in the amplifier 3521a included in the main controller unit 35a will be described.

It is assumed that an abnormality occurs in the amplifier 3521a included in the main controller unit 35a in a status in which the main controller unit 35a controls the electric actuator 23.

The abnormality detection circuit 29a included in the servo drive 352a turns off the power supplied to the brake 28 if an abnormality occurs in the amplifier 3521a. Accordingly, the brake 28 applies electromagnetic braking according to the turning off of the power supply (Step S1a).

In a case where an abnormality is detected, the abnormality detection circuit 29a sends the abnormality occurrence signal informing occurrence of an abnormality to the master controller 43.

If the master controller 43 receives the abnormality occurrence signal from the abnormality detection circuit 29a, the master controller 43 sends the execution command of the self diagnosis to the controller 351a.

If the execution command of the self diagnosis from the master controller 43 is input to the controller 351a, the self diagnosis is performed, and the execution command of the self diagnosis is output to the amplifier 3521a. If the execution command of the self diagnosis is input from the controller 351a to the amplifier 3521a, the amplifier 3521a performs the self diagnosis. The amplifier 3521a outputs the performed diagnosis result of the self diagnosis to the controller 351a. If the self diagnosis result is input from the amplifier 3521a to the controller 351a, the controller 351a sends the self diagnosis result of the amplifier 3521a and the self diagnosis result of the self amplifier to the master controller 43. Here, the master controller 43 detects the abnormality of the amplifier 3521a by acquiring the self diagnosis result indicating an abnormality (Step S2a).

If the master controller 43 detects the abnormality of the amplifier 3521a, the master controller 43 determines whether or not the preliminary controller unit 35b and the encoder 25 are normal (Step S3). For example, if the master controller 43 detects the abnormality of the amplifier 3521a, the master controller 43 executes the self diagnosis program by which whether or not the function is normal is determined, and outputs the instruction for returning the diagnosis result to each of the preliminary controller unit 35b and the encoder 25.

In addition, in a case where the master controller 43 receives the diagnosis results indicating normal states from both the preliminary controller unit 35b and the encoder 25, the master controller 43 determines that the preliminary controller unit 35b and the encoder 25 are normal (YES in Step S3).

In addition, in a case where the master controller receives the diagnosis result indicating abnormality from at least one of the preliminary controller unit 35b and the encoder 25, the master controller 43 determines that at least one of the preliminary controller unit 35b and the encoder 25 are not normal (NO in Step S3).

In the case where the master controller 43 determines that at least one of the preliminary controller unit 35b and the encoder 25 are not normal (NO in Step S3) in the processing of Step S3, the master controller 43 stops the operation of the steam turbine 10 and ends the processing.

In addition, in the case where the master controller 43 determines that the preliminary controller unit 35b and the encoder 25 are normal (YES in Step S3) in the processing of Step S3, the master controller 43 sends the amplifier primary power source interruption signal for interrupting the power supplied to the amplifier 3521a to the electromagnetic contactor 3522a included in the main controller unit 35a.

If the electromagnetic contactor 3522a receives the amplifier primary power source interruption signal from the master controller 43, the electromagnetic contactor 3522a becomes a non-conduction status. In addition, the electromagnetic contactor 3522a interrupts the power supplied to the amplifier 3521a (Step S4). In this case, the status storing unit 49 outputs the turbine rotating speed immediately before the master controller 43 detects the abnormality of the amplifier 3521a to the deviation counter 46 (Step S5a). For example, the status storing unit 49 includes a storage unit and a buffer circuit. The status storing unit 49 is connected to the negative input terminal of the deviation counter 46, and stores the turbine rotating speed for a predetermined period. In addition, in the case where the master controller 43 detects the abnormality of the amplifier 3521a, the status storing unit 49 outputs the turbine rotating speed stored immediately before the abnormality of the amplifier 3521a is detected based on the instruction from the master controller 43 to the negative input terminal of the deviation counter 46.

After the master controller 43 sends the amplifier primary power source interruption signal of the amplifier 3521a to the electromagnetic contactor 3522a included in the main controller unit 35a, the master controller 43 sends the switch control signal by which the connection destination of the electric actuator 23 is switched from the main controller unit 35a to the preliminary controller unit 35b to each of the magnet switch 44 and the encoder switch 45.

If each of the magnet switch 44 and the encoder switch 45 receives the switch control signal from the master controller 43, each of the magnet switch 44 and the encoder switch 45 switches the connection destination of the electric actuator 23 from the main controller unit 35a to the preliminary controller unit 35b (Step S6).

The preliminary controller unit 35b is connected to the electric actuator 23 by the processing of Step S6. If the main controller unit 35a is interrupted from the electric actuator 23, the controller 351a included in the main controller unit 35a sends an interruption completion signal informing interruption completion to the master controller 43 (Step S7a).

If the master controller 43 receives the interruption completion signal from the controller 351a, the master controller 43 sends the amplifier primary power source supply signal for supplying power to the amplifier 3521b to the electromagnetic contactor 3522b.

If the electromagnetic contactor 3522b receives the amplifier primary power source supply signal from the master controller 43, the electromagnetic contactor 3522b becomes a conduction status. In addition, the electromagnetic contactor 3522b supplies power from the primary power source to the amplifier 3521b (Step S8a). The amplifier 3521b supplies power to the brake 28 to release electromagnetic braking (Step S9). In this case, the turbine rotating speed immediately before the master controller 43 detects an abnormality is input from the status storing unit 49 to the deviation counter 46. As a result, the signal which is input to the preliminary controller unit 35b when the connection to the electric actuator 23 is switched from the main controller unit 35a to the preliminary controller unit 35b is the same as the signal which is input to the main controller unit 35a immediately before the master controller 43 detects an abnormality. That is, the parameter indicating the status in the steam turbine 10 is returned to the parameter indicating the status immediately before the master controller 43 detects an abnormality.

Here, the processing in which the turbine rotating speed is input from the status storing unit 49 to the deviation counter 46 is stopped (Step S10).

The master controller 43 sends the starting point set instruction for determining the starting point which becomes the reference of the rotation position of the electric motor 26 to the controller 351b.

If the controller 351b receives the starting point set instruction from the master controller 43, the controller 351b determines the starting point based on the input starting point set instruction (Step S11). For example, the controller 351b receives the starting point set instruction from the master controller 43, the controller 351b set the current rotation position of the electric motor 26 to the starting point.

In this way, the control in the steam turbine 10 is restored using the preliminary controller unit 35b.

Hereinbefore, the control in the steam turbine 10 in the case where an abnormality occurs in the amplifier 3521a included in the main controller unit 35a is described.

The status storing unit 49 stores the turbine rotating speed immediately before the master controller 43 detects the abnormality of the amplifier 3521a. The status storing unit 49 inputs the stored turbine rotating speed to the deviation counter 46. In this status, the main controller unit 35a is switched to the preliminary controller unit 35b. In addition, the status storing unit stops the processing by which the turbine rotating speed immediately before an abnormality is detected is input to the deviation counter 46.

Accordingly, the control in the steam turbine 10 can be restarted from the status immediately before the master controller 43 detects an abnormality. In addition, the master controller 43 can hold the deviation immediately before an abnormality of the controller 351a is detected, and a control of a gain of the PID controller 47 can be restarted from the gain immediately before an abnormality is detected. As a result, even in a case where an abnormality occurs in the controller unit which controls the drive of the electric motor, the steam turbine 10 is controlled such that the turbine rotating speed becomes the target turbine rotating speed, and it is possible to restore the control to a stable status in which damage does not occur.

In addition, in the above-described embodiment, the example in which the physical quantity which is detected in electric motor 26 input to the controller 351 via the servo drive 352 is the rotating speed and the rotation position is described. However, the present invention is not limited to this. For example, the physical quantity which is detected in electric motor 26 input to the controller 351 may be a current which flows to the electric motor 26, and may be a temperature at each location. In this case, the controller 351 specifies the valve opening degree based on the current or the temperature at each location.

Moreover, in the above-described embodiment, the example in which the controller unit 35 includes both the main controller unit 35a and the preliminary controller unit 35b is described. However, the present invention is not limited to this. The controller unit 35 may include three or more controller units.

In addition, in the above-described embodiment, the example of the parameter indicating the status in the steam turbine stored by the status storing unit 49 includes the turbine rotating speed of the turbine body 11 detected by the speed detection sensor 114, the valve opening degree for controlling the regulating valve 13, and the deviation between the target turbine rotating speed and the detected turbine rotating speed. However, the parameter is not limited to this. The parameter indicating the status in the steam turbine stored by the status storing unit 49 may be any parameter as long as it indicates the status in the steam turbine by which effects of the present embodiment can be obtained.

Hereinbefore, the steam turbine 10 according to the present embodiment is described. The above-described steam turbine 10 includes the electric motor 26 which drives the regulating valve 13 for regulating opening and closing the steam passage 12 through which steam supplied to the turbine body 11 is circulated. In addition, the steam turbine 10 includes the main controller unit 35a and the preliminary controller unit 35b for controlling the drive of the electric motor 26. In addition, the steam turbine 10 includes the status storing unit 49 which stores the parameters such as the turbine rotating speed of the turbine body 11 detected by the speed detection sensor 114, the valve opening degree for controlling the regulating valve 13, and the deviation between the target turbine rotating speed and the detected turbine rotating speed, and the parameters indicate the status in the steam turbine. In addition, the steam turbine 10 includes the master controller 43 which switches the controller unit to the preliminary controller unit 35b which is not controlling the electric motor in a case where there is an abnormality in the main controller unit 35a which controls the drive of the electric motor 26, and operates the preliminary controller unit 35b after rewriting the parameter to a parameter stored by the status storing unit 49 before an abnormality occurs.

Accordingly, even in a case where an abnormality occurs in the controller unit which controls the drive of the electric motor, the steam turbine is controlled such that the turbine rotating speed becomes the target turbine rotating speed, and it is possible to restore the control to a stable status in which damage does not occur.

In addition, the embodiments of the present invention are described. However, the above-described steam turbine 10 includes a computer system inside thereof. In addition, the above-described processing processes are stored in a recording medium in a program type readable by a computer, the program is read by the computer to be executed, and the processing is performed. Here, the recording medium readable by a computer includes a magnetic disk, an optical-magnetic disk, a CD-ROM, a DVD-ROM, a semiconductor memory, or the like. In addition, the computer program is transmitted to a computer via a communication circuit, and the computer receiving the transmission may perform the program.

In addition, the program may be a program which realizes a portion of the above-described functions. In addition, the program may be a so-called differential file (differential program) which the above-described functions can be realized by combination between the program and a program which is recorded in the computer system in advance.

The embodiment of the present invention is described. However, the embodiment is exemplified, and does not limit the scope of the present invention. Moreover, various omissions, replacements, and modifications can be applied to the present invention without does not depart from the gist of the present invention.

### INDUSTRIAL APPLICABILITY

According to the above-described steam turbine, control method, and program, even in a case where an abnormality occurs in the controller unit which controls the drive of the electric motor, the control is performed such that the turbine rotating speed becomes the target turbine rotating speed, and it is possible to restore the control to a stable status in which damage does not occur.

### REFERENCE SIGNS LIST

10: steam turbine

11: turbine body

12: steam passage

13: regulating valve

14: lever member

15: opening-closing drive mechanism

16: lock mechanism

17: electronic governor

18: compressor

19: lever side rod

20: pull spring

21: bracket

22: holding member

23: electric actuator

25: encoder

26: electric motor

27: conversion mechanism

28: brake

29a, 29b: abnormality detection circuit

30: ball screw

31: piston unit

32: coupling

34: operation panel

35a: main controller unit

35b: preliminary controller unit

36: lift sensor

43: master controller

44: magnet switch

45: encoder switch

46: deviation counter

47: PID controller

48: switch

49: status storing unit

111: casing

112: bearing

113: rotor

114: speed detection sensor

115: rotary shaft

116: blade

121: steam introduction port

122: steam supply port

123: throttle hole

131: arm member

132: sealing member

313: rod end connector

314: actuator side rod

351a, 351b: controller

352a, 352b: servo drive

3521a, 3521b: amplifier

3522a, 3522b: electromagnetic contactor (MC)

1. A steam turbine, comprising:
an electric motor which drives a regulating valve for regulating opening and closing of a steam passage through which steam supplied to a turbine body is circulated;
a plurality of controller units which control drive of the electric motor;
a status storing unit which stores a parameter indicating a status of the steam turbine; and
a master controller which switches the controller unit to a controller unit among the controller units which is not controlling the electric motor in a case where there is an abnormality in the controller unit which controls the drive of the electric motor, and operates the controller unit after rewriting the parameter to a parameter stored by the status storing unit before the abnormality occurs.

2. The steam turbine according to claim 1,
wherein the status storing unit stores a turbine rotating speed which is detected in the turbine body serving as the parameter.

3. The steam turbine according to claim 1,
wherein the status storing unit stores a valve opening degree for controlling the regulating valve serving as the parameter.

4. The steam turbine according to claim 1,
wherein the status storing unit stores a deviation between a target turbine rotating speed and the detected turbine rotating speed serving as the parameter.

5. A control method of a steam turbine, comprising:
a plurality of controller units which control drive of an electric motor which drives a regulating valve for regulating opening and closing of a steam passage through which steam supplied to a turbine body is circulated;
a status storing unit which stores a parameter indicating a status of the steam turbine; and
a master controller which switches the controller unit to a controller unit among the controller units which is not controlling the electric motor in a case where there is an abnormality in the controller unit which controls the drive of the electric motor, and operating the controller unit after rewriting the parameter to a parameter stored by the status storing unit before the abnormality occurs.

6. A program causing a computer to operate:
an electric motor which drives a regulating valve for regulating opening and closing of a steam passage through which steam supplied to a turbine body is circulated;
a plurality of controller units which control drive of the electric motor;
a status storing unit which stores a parameter indicating a status of the steam turbine; and
a master controller which switches the controller unit to a controller unit among the controller units which is not controlling the electric motor in a case where there is an abnormality in the controller unit which controls the drive of the electric motor, and operates the controller unit after rewriting the parameter to a parameter stored by the status storing unit before the abnormality occurs.

7. The steam turbine according to claim 2,
wherein the status storing unit stores a valve opening degree for controlling the regulating valve serving as the parameter.

8. The steam turbine according to claim 2,
wherein the status storing unit stores a deviation between a target turbine rotating speed and the detected turbine rotating speed serving as the parameter.

9. The steam turbine according to claim 3,
wherein the status storing unit stores a deviation between a target turbine rotating speed and the detected turbine rotating speed serving as the parameter.
